(19) United States
(12) Patent Application Publication
(10) Pub. No.: US 2010/0213031 A1
(43) Pub. Date: Aug. 26, 2010

(54) SORTING SYSTEM FOR SORTING BULK GOODS

(76) Inventors: Dietmar Krech, Kaiserslautern (DE); Torsten Tanz, Hilzingen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/680,966

(22) PCT Filed: Oct. 1, 2008
(86) PCT No.: PCT/EP2008/063117

§ 371 Date: Mar. 31, 2010

(30) Foreign Application Priority Data
Oct. 1, 2007 (DE) 10 2007 047 000.4

(51) Int. Cl. B65G 37/00

(52) U.S. Cl. 198/574

(57) ABSTRACT

A sorting system for sorting bulk goods is disclosed. A plurality of sorter elements are guided in a contactless manner along a horizontal track of a stationary guideway. The sorter elements being driven in a contactless manner in the direction of transport. One bulk good is transported on each sorter element, either on one at a time or resting on several sorter elements, from a loading point to an unloading point, where it is loaded and/or unloaded transversally to the direction of transport. The sorter elements carry the load in a suspended manner.

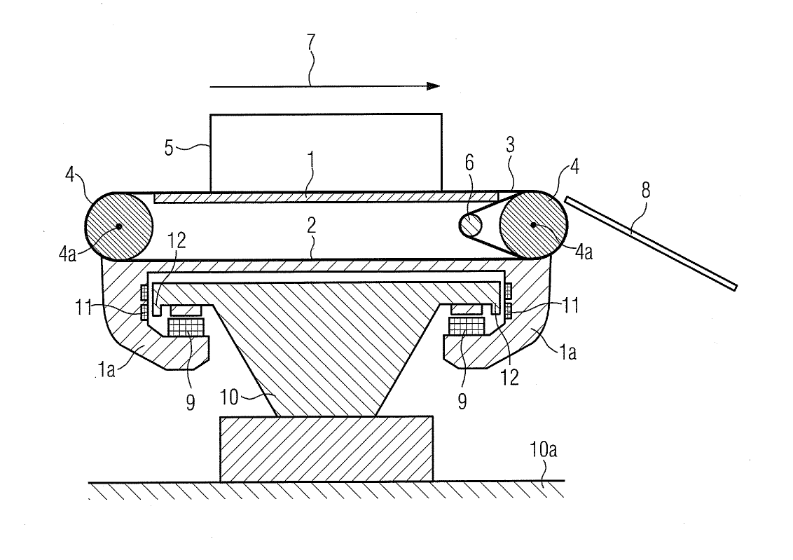

### CROSS REFERENCE TO RELATED APPLICATIONS

This application is the US National Stage of International Application No. PCT/EP2008/063117, filed Oct. 1, 2008 and claims the benefit thereof. The International Application claims the benefits of German application No. 10 2007 047 000.4 DE filed Oct. 1, 2007. All of the applications are incorporated by reference herein in their entirety.

### FIELD OF INVENTION

The invention relates to the drive and the load shedding in a sorting system for sorting bulk goods, in which a multiplicity of sorter elements driven in the transport direction revolve in a guided manner along a horizontal track, preferably closed on itself, on which sorter elements in each case a bulk goods item is transported, complete or lying in place over a plurality of sorter elements, from a loading station to an unloading station, where it is loaded on or loaded off transversely to its transport direction.

### BACKGROUND OF INVENTION

Sorting systems for sorting bulk goods are generally known, and they usually consist of a horizontally or vertically revolving line-up of sorter elements which carry the bulk goods to be sorted to the destination (sorter target). The individual sorter elements may in this case revolve both individually in the manner of rail-guided wagons or be coupled to one another to form a train. In many sorters, the sorter elements revolve on a track closed on itself and are joined together into an endlessly revolving chain.

### SUMMARY OF INVENTION

In the generic sorters, a basic distinction is made between two sorter types, to be precise the crossbelt sorter and the tilting-tray sorter which are capable of being used in a 2D and/or 3D configuration. In the tilting-tray sorters, the bulk goods are transported on tray-shaped supports which are mounted tiltably on the frame of the sorter elements. The supporting trays, held horizontally during transport, are brought into an oblique attitude in the unloading position as a result of the activation of a drive specifically about a horizontal axis oriented in the transport direction, so that the supported bulk goods pass laterally from the sorter onto an oblique plane or chute as a result of the inclination of the supporting trays.

The bulk goods are brought from there to a target position as a result of gravity or by means of driven conveyors.

Crossbelt sorters consist of a conveyer belt which is arranged on the frame of the sorter element and which is guided endlessly around two spaced-apart transport rollers oriented in parallel on both sides of the transport direction in terms of their axes of rotation and is movable transversally with respect to the transport direction of the sorter by means of the drive of at least one of the transport rollers or by means of a frictional connection of a drive with the conveyer belt. The bulk goods lie on the upper strand of the conveyer belt which is stationary during transport. In the unloading position, the conveyer belt is set in motion via the drive of the transport rollers and transports the bulk goods from the crossbelt onto a laterally arranged inclined chute, from where it arrives at the target position. In both instances, a drive is required for activating both the deflecting rollers and the tilting device. The drives are activated either electrically or mechanically, for which purpose corresponding devices are provided in the unloading positions. The present invention is concerned both with the drive of the sorter elements in the transport direction and with the drive to be activated for unloading the sorter elements in the unloading positions.

Predominantly mechanical drives are used for advancing the sorter elements, the sorter elements being provided with running rollers, via which the load is shed to the rails laid in the transport direction. The known solutions have disadvantages because they are subject to high wear, are susceptible to dust and other deposits and, moreover, generate high noise during rotation.

Supplying the revolving sorter elements with electrical drive energy at the present time presents problems with regard to reliability and/or to cost.

If, for example, a drive according to the prior art is considered, in which a wagon chain, as it is known, is formed, by means of a closed line-up of sorter elements, the drive takes place there mechanically by means of positive connection, for example in the case of chainwheel drag chains and wormshaft drives, or by nonpositive connection (by means of friction wheel drives). However, electrodynamic drives by means of stationary, vertically or horizontally arranged linear drives are also already being used. Irrespective of what type of drive is used, vertical and horizontal load sheddings via running wheels, which roll on planar or circular surfaces (rails), are always required.

For the supply of energy to sorter elements to be activated electrically or driven electromotively, two solutions are basically used, the first being characterized in that the transmission of energy to the sorter elements takes place via wiper contacts which are arranged along the track and which maintain a connection to the stationary energy source at each point of the sorter revolution. An appreciable disadvantage of this solution is the mechanical wear and the susceptibility to dirt. However, the high costs also have an adverse effect, since the wiper contact lines have to be installed over the entire sorter revolution length and therefore a high outlay in terms of material and long assembly times have to be expected.

In a second known solution, a transmitting device is provided on the entire surface of revolution of the sorter elements and is assigned a plurality of receiving devices or receiving devices arranged on all the sorter elements. Contactless energy transmission is implemented via this transmitting and receiving device and takes place via electrical fields of the most diverse possible configurations.

The object on which the present invention is based is to provide a generic sorting system which is less sensitive to dust and deposits, and which has lower sound emissions and is improved in terms of reliability and maintenance costs, as compared with the known solutions.

To achieve the object, it is proposed, according to the invention, that both the drive and the guidance of the sorter elements take place contactlessly, and the loading shedding of the sorter elements takes place in a suspended manner above a carrier rail laid along the travel route. The present invention consequently deliberately dispenses with the running roller guidance used hitherto and utilizes the suspension railroad technology, known per se in the art, for the generic bulk goods sorting contrivances.

According to a refined feature of the invention, the drive, guidance and load shedding of the sorter elements take place electromechanically. The invention therefore adopts the principle of the mutual attraction and repulsion of magnetic fields, depending on their polarity. By means of the exerted forces, objects having magnetic properties can be moved counter to gravity and to other acting forces, as long as the force of the magnetic field is higher that the counteracting forces.

In a refinement of the invention, there is provision whereby, for guidance load shedding, guiding and carrying magnets are arranged on the carrier rail and are controllable by means of an electronic control system so that a uniform distance of the sorter element from the carrier rail can be maintained.

Alternatively, according to the invention, it is proposed that, for guidance and load shedding, guiding and carrying magnets be arranged in a co-travelling manner on the sorter elements and be controllable by an electronic control system so that a uniform distance of the sorter element from the carrier rail can be maintained. As a result, the invention allows a permanent free “suspension” and a simultaneous travelling movement by means of static and unregulated magnetic fields, this ultimately being made possible by a sufficiently rapid and efficient dynamic control.

To drive the sorter elements in the transport direction, a linear motor is used, preferably a synchronous stator linear motor, which generates a magnetic travelling wave field which is propogated along the carrier rail and which drags along the sorter elements via the guiding and/or carrying magnets arranged fixedly on the sorter elements. This linear motor is installed in the travel route and functions basically in the same way as a conventional electric motor, the stator of which is cut open and extended underneath the travel route. The current of the linear motor generates in the cable windings a magnetic travelling wave field by which the closed wagon chain is pulled along contactlessly. The carrying magnets in this case act as an exciter part (rotor), while the transport speed of the sorter elements can be regulated continuously by a variation in the frequency of the motor.

In a further refinement of the invention, it is proposed that the frequency and/or intensity of the travelling wave field generated be varied for the purpose of accelerating and braking the sorter elements. By the frequency of the three-phase current being varied, the speed of the sorter elements can be regulated continuously. If the direction of force of the travelling wave field is changed, the motor becomes a generator and brakes the wagon chain contactlessly. The brake energy which in this case occurs can be utilized again and fed back as electrical energy.

Preferably, the entire travel route of the sorter elements is designed as a stator of the linear motor, but this switches on only the stator coils of that travel route on which sorter elements to be moved forward are located. Energy can thereby be saved, since the drive is restricted to that part of the conveyer which is actually required for driving a conveying element.

In an especially beneficial refinement of the invention, there is provision whereby, on the sorter elements, linear generators are arranged, the inductively generated energy of which can be fed in for the purpose of driving sorter elements which are to be activated electrically and/or which can be driven electromotively. Linear generators act virtually in reverse to a linear motor, and they are suitable for generating current by induction during the travelling movement. This current can then be fed into the system, that is to say into the sorter elements when, as a feature in the invention provides, the linear generators are integrated in the guiding and/or carrying magnets of the sorter elements.

It is especially beneficial if according to another feature of the invention it is proposed that the energy generated in the linear generators is storable in suitable intermediate stores of the sorter elements. The intermediate stores (accumulators or the like) are suitable for temporarily absorbing energy and discharging it briefly, for example in the unloading stations, where the energy can be used in order to activate the drives for the tilting trays or crossbelts.

Beneficially, the linear generator uses harmonics of the driving magnetic field for obtaining its energy via electromagnetic induction. These harmonics arise on account of the slots of the long stator, in which the stator cables are laid, and of the resulting time variations as seen from the wagon chain, in the magnetic conductivity of the magnetic circuits involved. The energy generation of the linear generator therefore does not take place via the useful magnetic field, but, instead, via secondary effects which arise due to the slots in the long stator.

The invention has a series of advantages. Owing to the contact-free drive and the suspended forward movement of the sorter elements, no wear arises as a result of friction. Fine dust pollution occurring due to friction is thereby avoided, and a grinding or milling of the travel route is no longer required. The drive power is lower than in known systems, since rolling friction forces no longer have to be overcome. In general, the system is insensitive to dust and other deposits, this being conducive to higher reliability and to lower maintenance costs. The low sound emission, as compared with conventional wheel/rail technology, is especially to be stressed. Furthermore, the weight of the sorter elements does not act upon the rail via point loads, as in the case of a wheel, but, instead, distributed over the entire wagon body length, acts as a line load upon the travel route.

### BRIEF DESCRIPTION OF THE DRAWINGS

An exemplary embodiment mentioned is illustrated in the drawing and is described below. This shows in a simplified illustration, a cross section through a sorter element which in the present case is designed as a crossbelt sorter.

### DETAILED DESCRIPTION OF INVENTION

The sorter element 1 is executed in magnetic levitation technology and is movable along the travel route 2. The latter is formed from a carrier rail 10 which is fastened to the ground on a foundation 10a. The sorter element 1 surrounds this carrier rail 10, having a T-shaped configuration in the upper region, on both sides, from below, by means of inwardly directed frame parts 1a, in which magnets for carrying and guiding the sorter elements 1 are arranged. The carrying magnets 9 are arranged so that their magnetic force is directed upward and causes an attraction of the sorter elements 1 toward the carrying magnets 9 directed downward on the carrier rail 10. A corresponding control ensures that the distance between the carrying magnet 9 and its guide track is

As illustrated in the drawing, a crossbelt 3 is arranged on the top side of the frame of the sorter element 1 and is looped around drivable deflecting rollers 4 mounted on both sides of the sorter element 1. The axes of rotation 4a of the deflecting rollers run parallel (perpendicularly to the drawing plane) to the transport direction, so that the crossbelt 3 therefore revolves transversely to the transport direction. As illustrated, a bulk goods item 5 lies on the upper strands of the crossbelt 3 and is held there during transport. In the unloading position shown, the deflecting roller 4 is set in rotation by starting the symbolized motor 6 and causes the crossbelt 3 to revolve in the direction of the arrow 7. The bulk goods item 5 consequently moves (to the right in the drawing) onto the oblique plane 8 which is designed as a chute so that the bulk goods item is shed from the sorter element 1 and delivered to a target location.

During transport, the carrying magnets 9 cause the sorter element 1 to be suspended just above the travel route 2 of the carrier rail 10, without said sorter element coming into contact with the latter. So that bends can likewise be negotiated without contacts between the carrier rail 10 and the sorter element 1 and in order to prevent an oscillation of the sorter element 1 on the carrier rail 10 guiding magnets 11 are provided laterally on the carrier rail 10 and on the frame of the sorting element 1 and are likewise regulated so that a uniform distance between the magnets 11 and the guide rail 12 is ensured on the carrier rail 10. In addition to the carrying and guiding magnets 9, 11, linear generators (not illustrated) may be formed by cable windings which are integrated additionally into the carrying magnets 9 and in which current is induced contactlessly during travel and is used in the unloading station for activating the drives for the deflective rollers 4. An intermediate storage of the generator-produced current is to be recommended, so that the energy can be picked off briefly for unloading the crossbelts 3.

1.-11. (canceled)

12. A sorting system for sorting bulk goods, comprising:
a horizontal track with a stationary travel route; and
a plurality of sorter elements guided contactlessly along a the horizontal track are driven contactlessly in a transport direction from a loading station to an unloading station, where a bulk good item transported on the sorter element is loaded or unloaded transversely to the transport direction, and the unloading of the sorter element occurs in a suspended manner above a carrier rail laid along the stationary travel route.

13. The sorter system for sorting bulk goods as claimed in claim 12, wherein the horizontal track is closed.

14. The sorter system for sorting bulk goods as claimed in claim 12, wherein the drive, guidance and unloading of the sorter elements occur electromagnetically.

15. The sorter system for sorting bulk goods as claimed in claim 14, further comprising:
a plurality of carrying magnets and a plurality of guiding magnets are arranged on the carrier rail and are controllable via an electronic control system so that a uniform distance of the sorter element from the carrier rail is maintained.

16. The sorter system for sorting bulk goods as claimed in claim 12, further comprising:
a plurality of carrying magnets and a plurality of guiding magnets are arranged on the carrier rail and are controllable via an electronic control system so that a uniform distance of the sorter element from the carrier rail is maintained.

17. The sorter system for sorting bulk goods as claimed in claim 14, further comprising:
a plurality of carrying magnets and a plurality of guiding magnets are arranged in a co-travelling manner on each of the plurality of sorting elements and are controllable via an electronic control system so that a uniform distance of the sorter element from the carrier rail is maintained.

18. The sorter system for sorting bulk goods as claimed in claim 12, further comprising:
a plurality of carrying magnets and a plurality of guiding magnets are arranged in a co-travelling manner on each of the plurality of sorting elements and are controllable via an electronic control system so that a uniform distance of the sorter element from the carrier rail is maintained.

19. The sorter system for sorting bulk goods as claimed in claim 12, further comprising:
a linear motor that generates a magnetic travelling wave field which is propagated along the carrier rail and which transports the sorter elements via a plurality of guiding and a plurality of carrying magnets a arranged fixedly on the sorter elements.

20. The sorter system for sorting bulk goods as claimed in claim 19, wherein the linear motor is a synchronous stator linear motor.

21. The sorter system for sorting bulk goods as claimed in claim 19, wherein the frequency and/or intensity of the travelling wave field generated is varied for the purpose of accelerating and braking the sorter elements.

22. The sorter system for sorting bulk goods as claimed in claim 20, wherein
the carrier rail of the sorter elements is designed as a stator of the linear motor, which switches on only the stator coils of the stationary travel route on which a sorter element of the plurality of sorter elements to be transported is located.

23. The sorting system for sorting bulk goods as claimed in one of claims 1 to 7, further comprising:
a linear generator is included with each of the plurality of sorter elements, the linear generator inductively generates energy to drive the respective sorter element which is activated electrically and/or which is driven electromotively.

24. The sorting system for sorting bulk goods as claimed in claim 23, wherein the linear generator is integrated in the guiding and/or carrying magnets of the sorter elements.

25. The sorting system for sorting bulk goods as claimed in claim 24, wherein the energy generated via the linear generators is stored in suitable intermediate stores of the sorter elements.

26. The sorting system for sorting bulk goods as claimed in claim 23, wherein the linear generator uses harmonics of the driving magnetic field for obtaining energy via electromagnetic induction.
